(19) United States
(12) Patent Application Publication
(10) Pub. No.: US 2026/0365094 A1
(43) Pub. Date: Nov. 19, 2026

(54) TRIM RETAINER FOR A SEAT ASSEMBLY

(71) Applicant: Lear Corporation, Southfield, MI (US)

(72) Inventors: Michael Weitlauer, Fraunberg (DE); Markus Manternach, Munich (DE); Johannes Krimmer, Kirchdorf (DE); Peter Festag, Erding (DE)

(21) Appl. No.: 19/675,546

(22) Filed: May 13, 2026

(30) Foreign Application Priority Data
May 14, 2025 (DE) 102025118608.1

(51) Int. Cl. B60N 2/72

(52) U.S. Cl. CPC B60N 2/72

(57) ABSTRACT

Disclosed is a trim retainer for a seat assembly. The trim retainer comprises a retention member and a support member extending from the retention member. The retention member is adapted to be disposed at a portion of a seat frame and adapted to engage with the portion of the seat frame. The retention member is adapted to at least partially engage with a trim cover and pull the trim cover towards the portion of the seat frame. The support member is adapted to guide the trim cover such that a movement of a seat cushion is restricted with respect to seat frame. In various non-limiting examples, the trim retainer may ensure secure fixation of trim cover and seat cushion to the seat frame, thereby enhancing the appearance and functionality of the seat assembly.

### TECHNICAL FIELD

The present disclosure relates to a trim retainer. More specifically, the present disclosure relates to the trim retainer for a seat assembly and a seat assembly.

### BRIEF DESCRIPTION OF THE DRAWINGS

FIGS. 1A and lB illustrate a schematic illustration of a trim retainer attached to a portion of a seat assembly, in accordance with an exemplary embodiment of the present disclosure;

FIG. 2A illustrates a schematic illustration of a side view of a trim retainer, in accordance with another exemplary embodiment of the present disclosure;

FIG. 2B illustrates a schematic illustration of the trim retainer creating tension in a trim cover, in accordance with another exemplary embodiment of the present disclosure;

FIG. 3A illustrates a schematic illustration of a trim retainer, in accordance with yet another exemplary embodiment of the present disclosure; and

FIG. 3B illustrates a schematic illustration of a perspective view of the trim retainer, in accordance with yet another exemplary embodiment of the present disclosure.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Vehicle seats include various components such as a seat back and a seat cushion or bottom. The seat back is commonly pivotally attached to the seat bottom. Each of the seat back and the seat bottom typically incorporate a cushion or padding, covered by a trim cover. The trim cover is designed for decorative and protective purposes. The appearance of the seat is a critical factor influencing consumer purchasing decisions. Consequently, maintaining a smooth, wrinkle-free trim cover is crucial for preserving the vehicle's overall aesthetic appeal. Furthermore, apart from aesthetics or bad appearance, the formation of wrinkles or creases on the trim cover also leads to other problems such as, but not limited to, accumulation of dirt around the same or faster wear and tear of the fabric.

The present disclosure provides a trim retainer that provides a secure and stable attachment of the trim cover to the seat frame. In this regard, the trim retainer comprises a retention member and a support member that extends away from the retention member. The retention member is adapted to be disposed at a portion of the seat frame and is adapted to engage with the seat frame effectively. Said configuration allows the retention member to at least partially engage with the trim cover and pull the trim cover towards the seat frame, thereby maintaining an accurate tension in the trim cover. The accurate tension prevents sagging or loosening of the trim cover over time, which is crucial for maintaining the aesthetic appearance and structural integrity of the seat assembly of the vehicle. Additionally, the support member is adapted to guide the trim cover in such a manner that the movement of the seat cushion is restricted with respect to the seat frame. The guided restriction minimizes unwanted movements of the seat cushion, such as upward or lateral shifts, thereby preventing discomfort to the occupant and generation of noise, such as squeaking.

It will be appreciated that the retention member and the support member work in conjunction with each other to create a mechanism that securely fixes both the trim cover and the seat cushion to the seat frame. In this regard, the retention member allows a tight engagement and pulling force on the trim cover, while the support member directs and limits the cushion's movement, thus distributing the forces evenly and reducing localized stress points. Said coordinated function also simplifies the assembly process by providing a robust and simple means of securing the seat components.

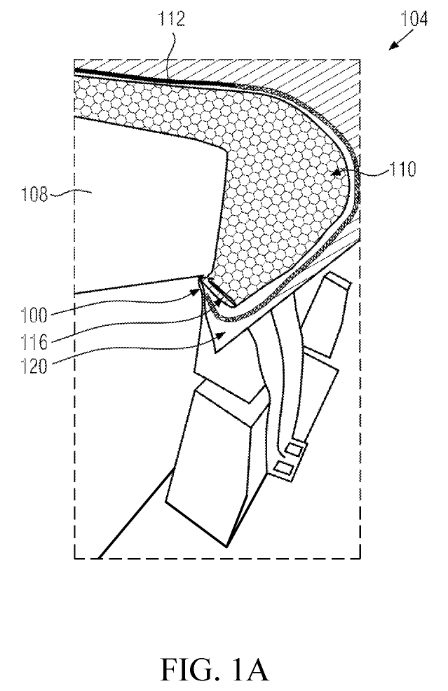

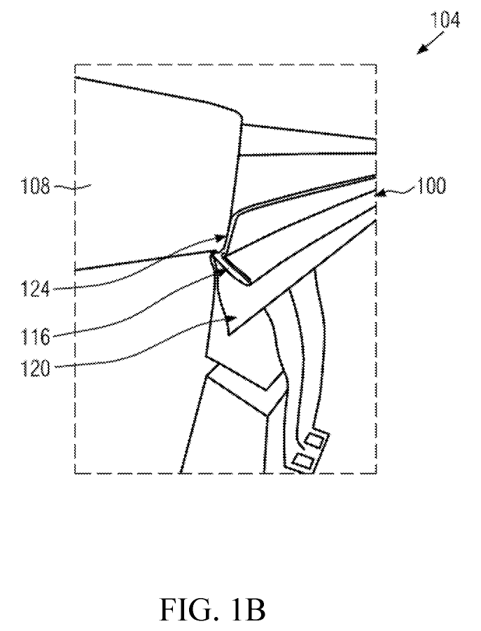

Referring to FIG. 1A, illustrated is a schematic illustration of a trim retainer 100 attached to a portion of a seat assembly 104, in accordance with an exemplary embodiment of the present disclosure. As shown, the seat assembly 104 can be a vehicle seat assembly. In various examples, the seat assembly 104 may be shaped and sized as a front row driver or passenger seat, a second, third, or other rear-row seat. Additionally, the seat assembly 104 may be adapted for use with other non-vehicle applications. In an example, the seat assembly 104 may be utilized for any seating arrangement, such as a land vehicle, a lounge chair, aircraft, watercraft, or the like. In an embodiment, the seat assembly 104 comprises one or more seat members. Typically, the seat assembly 104 includes a seat frame 108, a seat cushion 110 on which a user may sit, a seatback against which a user may lean, such as when sitting on the seat cushion 110, a trim cover 112 and/or a headrest. As shown, the seat assembly 104 comprises the seat cushion 110 adapted to be attached to the seat frame 108. The seat cushion 110 may be mounted to the seat frame 108 that can be removably attached to the vehicle floor. The seat cushion 110 may be conventionally attached to the seat frame 108 by any method well known in the art. In an example embodiment, each seat cushion 110 can be one or more pieces of foam that are bonded together to form a seat component. In this regard, the seat cushion's 110 stability can enhance seating comfort by maintaining its intended shape and position and can also prevent discomfort caused by shifting or bunching. Moreover, the seat cushion 110 also protect the underlying seat frame 108 from damage caused by excessive friction or wear.

Further, the seat assembly 104 can include the seat back that can be a conventional seat frame 108, such as those stamped or welded together from suitable metals, such as aluminum, steel, or other metal alloys, instead of one made of structural polymer material. As shown, the seat assembly 104 can include the trim cover 112 adapted to cover the seat cushion 110. The seat back and the seat bottom of the vehicle seat include the seat cushion 110 or padding, that can be covered by trim cover 112 to provide a smooth seating surface, aesthetic appearance, and comfort. Moreover, the trim cover 112 not only decoratively covers the seat cushion 110 but also serves to protect the seat cushion 110 from wear and tear.

The trim cover 112 can be fabricated using materials such as leather, vinyl, fabric, or combinations thereof. In an example embodiment, the trim cover 112 can be fabricated using a leather material. In some examples, the leather material can be leatherette or faux leather, that is used to provide durability, breathability, and luxurious appearance to the seat assembly 104. In another example embodiment, the trim cover 112 can be fabricated using a vinyl material. Notably, the vinyl material is a synthetic material that is used as a cost-effective alternative to the leather material. Moreover, the vinyl material provides durability and waterproof properties to the trim cover 112. It will be appreciated that the vinyl material provides stiffness to the trim cover 112. In another example embodiment, the trim cover 112 can be fabricated using a polymer material that provides a range of properties from flexibility to rigidity, making the polymer material versatile for different design requirements.

There is also shown a trim retainer 100 that is adapted to be engaged with the seat frame 108 and the trim cover 112. Herein, the trim retainer 100 can be a mechanical device or assembly designed to secure and position a flexible covering, such as the trim cover 112, relative to a rigid substrate, such as the seat frame 108. In an example embodiment, the trim retainer 100 can be detachably coupled to the seat frame 108. The trim retainer 100 can be adapted to be disposed at a portion of the seat frame 108 and adapted to engage with the portion of the seat frame 108. Further, the trim retainer 100 can be disposed between the seat cushion 110 and the seat frame 108. In such an embodiment, the trim retainer 100 can be used to secure the seat cushion 110 in place and prevent the seat cushion 110 from shifting or moving during use. In another embodiment, the trim retainer 100 can be positioned between the seat back and the seat frame 108, where the trim retainer 100 can maintain the position of the seat back and prevent wrinkles providing a tight, smooth appearance. In an embodiment, the trim retainer 100 can be utilized at the connection points between the headrest and the seat back. In an example embodiment, the trim retainer 100 can secure the headrest cover, preventing the headrest cover from sliding or becoming dislodged, thereby enabling consistent positioning and safety. In another example embodiment, the trim retainer 100 can be applied on the side bolsters of the seat assembly 104 to hold the trim cover 112 tightly against the side bolsters, thereby maintaining the shape and providing additional support to the occupant. In another example embodiment, the trim cover 112 can be connected to the bottom frame, which can secure any under seat upholstery or trim pieces, thereby securing the seat upholstery or the trim pieces in place without interference with the seat's movement mechanisms. In another example embodiment, the trim retainer 100 can be used between the armrest and the seat frame 108 or armrest frame to secure the armrest cover, preventing the armrest cover from shifting or sagging over time.

The trim retainer 100 comprises the retention member (as shown in FIG. 1B) and a support member 116 that extends from the retention member. Herein, the support member 116 is a structural component designed to assist in maintaining the desired position and tension of the trim cover relative to the seat frame 108. In an embodiment, the retention member and the support member 116 can be integrally molded as a single piece using materials such as plastic or metal. In such an embodiment, the trim retainer 100 enables a seamless and strong connection between the retention member and the support member 116.

In accordance with some example embodiments described herein, the support member 116 is designed and/or adapted of a shape such that, upon engagement of the trim cover 112 over the support member, the shape of the support member 116 guides the trim cover 112 such that a movement of the seat cushion 110 is restricted with respect to the seat frame 108. In this regard, the support member 116 creates a guiding path for the trim cover 112 by extending from the retention member at a precise angle. The support member 116 enables that the trim cover 112 remains taut and correctly positioned over the seat cushion 110. The tension prevents the seat cushion 110 from shifting, lifting, or moving laterally, thereby maintaining its intended position on the seat frame 108. The secure attachment provided by the support member 116 enables that any forces exerted on the seat cushion 110, such as those from the occupant movement or the vehicle motion, are effectively countered. The countered forces keep the seat cushion 110 stable and securely in place. The stability is crucial for maintaining the comfort, safety, and overall integrity of the seat assembly 104.

There is also shown a first layer 120 adapted to be at least partially attached to the retention member. Herein, the first layer 120 is an additional layer adapted to be attached to the trim retainer 100 that provides an interface between the trim cover 112 and the retention member. In an embodiment, the first layer 120 is adapted to facilitate an attachment of the trim cover with the retention member. In an embodiment, the first layer 120 can be an intermediary layer that enhances the connection between the trim cover 112 and the retention member. In an embodiment, the first layer 120 can be made from various materials that offer properties such as adhesion, friction, or flexibility, which aid in securing the trim cover 112 to the retention member. In one embodiment, the first layer 120 can have an adhesive surface that bonds directly to the trim cover 112, providing a firm attachment that prevents slippage. Alternatively, the first layer 120 could be made from a high-friction material, providing a gripping surface that holds the trim cover 112 in place through mechanical friction. In an embodiment, the first layer 120 may also have a textured or contoured surface designed to interlock with corresponding features on the trim cover 112, thus securing the trim cover 112 through physical engagement. Furthermore, in some embodiments, the first layer 120 might be elastic or flexible, allowing the first layer 120 to conform to the shape of the trim cover 112 and the retention member, thereby accommodating variations in shape and enabling a snug fit.

Referring to FIG. 1B, illustrated is a schematic illustration of the trim retainer 100 attached to a portion of the seat assembly 104, in accordance with an exemplary embodiment of the present disclosure. As shown, the trim retainer 100 is adapted to be engaged with the seat frame 108 and the trim cover 112 (as depicted in FIG. 1A). The trim retainer 100 comprises a retention member 124 and the support member 116 that extends from the retention member 124. In an embodiment, the support member 116 extends from the retention member 124 at a predetermined angle within a range from about 10 degrees to about 120 degrees. In another embodiment, the support member 116 extends from the retention member 124 at a predetermined angle within a range from about 20 degrees to about 110 degrees. In another embodiment, the support member 116 extends from the retention member 124 at a predetermined angle within a range from about 40 degrees to about 90 degrees. It will be appreciated that the aforementioned range allows for flexibility in the design of the trim retainer 100, thus accommodating different seat frame 108 geometries and trim cover 112 requirements. In other words, the aforementioned range enables the trim retainer 100 to adapt to various designs and configurations of the seat assembly 104, thereby guiding and securing the trim cover 112 effectively regardless of the shape or size of the seat frame 108. Additionally, the predetermined angle maintains the alignment and tension of the trim cover 112.

In an alternative embodiment, the angle of the support member 116 could be adjustable, allowing for on-the-fly modifications during assembly or adjustments for different vehicle models. In such an embodiment, a hinged or pivoting connection between the retention member 124 and the support member 116 is required. The trim retainer 100 is adapted to be disposed at a portion of the seat frame 108 and adapted to engage with the portion of the seat frame 108. In an embodiment, said disposition allows the retention member 124 to be placed at any relevant location on the seat frame 108, thus providing versatility in design and application of the trim retainer 100. The retention member 124 is adapted to at least partially engage with the trim cover 112 (as described in FIG. 1A). In an embodiment, the partial engagement may include connecting a portion of the seat frame 108 with the retention member 124 such that the seat frame 108 is partially inserted into the retention member 124. In another embodiment, the retention member 124 may include a cavity to receive a bottom portion of the seat frame 108 of the seat back. It will be appreciated that a portion of the retention member 124 is secured to the trim cover 112 from its one end in order to exert a pulling force on the trim cover 112.

In an embodiment, the support member 116 is adapted to guide the trim cover 112 such that a movement of the seat cushion 110 is restricted with respect to the seat frame 108. The support member 116 is adapted to guide the trim cover 112 such that the seat cushion 110 is fixed between the seat frame 108 and the trim cover 112. In such an embodiment, the support member 116 enables the trim cover 112 to follow a predetermined path, thereby holding the seat cushion 110 firmly in place. In another embodiment, the support member 116 might include adjustable features to customize the tension and positioning of the trim cover 112. Additionally, the support member 116 could be constructed from materials with different rigidity levels to provide varying degrees of support and flexibility.

There is also shown a first layer 120 adapted to be at least partially attached to the retention member. In an embodiment, the first layer 120 is adapted to facilitate an attachment of the trim cover with the retention member 124. In an embodiment, the first layer 120 can be adhered to the retention member 124 using a high-strength adhesive. The adhesive can be applied to specific regions of the retention member 124 where the first layer 120 will be attached, enabling a secure bond. In another embodiment, the first layer 120 can be attached to the retention member 124 using heat sealing. In another embodiment, mechanical fasteners such as staples or clips can be used to secure the first layer 120 to the retention member 124. In an embodiment, the first layer 120 is at least partially attached to a portion of the retention member 124 such that the first layer 120 is sandwiched between the retention member 124 and the trim cover 112. Said configuration facilitates the attachment process by providing a stable and adaptable interface that can be easily sewn or otherwise secured to the trim cover 112. In an embodiment, the first layer 120 is adapted to be fabricated using at least one of: a nonwoven material, a spacer fabric, a fleece, an elastic material, a textile, or a combination thereof. It will be appreciated that by employing materials such as the nonwoven fabric, the spacer fabric, the fleece, the elastic material, or the textile, or the combination thereof, the first layer 120 is engineered to conform to the intricate contours of the seat cushion 110 while establishing a secure bond with the trim cover 112 and retention member 124. Said flexibility is crucial for maintaining the aesthetic appeal and functionality of the seat assembly 104. The choice of material also impacts the first layer's 120 breathability, durability, and acoustic properties, contributing to overall seat comfort and performance. In such an embodiment, the nonwoven materials offer high durability and resistance to wear and tear. It will be appreciated that the nonwoven materials provide a stable and consistent interface that enhances the longevity of the trim cover 112. Moreover, the nonwoven materials are also lightweight and can be easily shaped, making the nonwoven materials ideal for maintaining the trim cover's 112 form and fit.

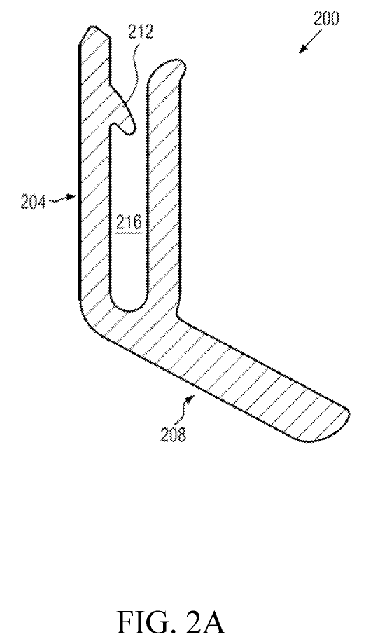

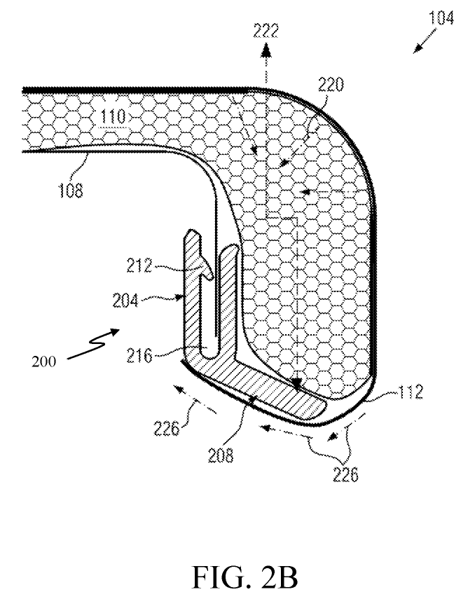

Referring to FIG. 2A illustrated is a schematic illustration of a side view of a trim retainer 200, in accordance with another exemplary embodiment of the present disclosure. As shown, the trim retainer 200 comprises a retention member 204 and a support member 208 extending from the retention member 204. The retention member 204 is adapted to be disposed at a portion of a seat frame 108 (as described in FIGS. 1A and 1B) and adapted to engage with the portion of the seat frame. The retention member 204 is adapted to at least partially engage with the trim cover 112 (as described in FIG. 1A) and pull the trim cover 112 towards the portion of the seat frame 108 of the seat assembly 104. The support member 208 is adapted to guide the trim cover 112 such that a movement of a seat cushion 110 is restricted with respect to the seat frame 108. As shown, the retention member 204 comprises a U-shaped configuration. As shown, the retention member 204 comprises two parallel ribs, thus forming the U-shaped configuration. In an embodiment, the seat frame 108 is adapted to be received between the two ribs of the retention member 204. The seat frame 108 is designed to fit between the two ribs of the retention member 204 that enables a snug fit and prevents unwanted movement of the seat cushion 110 (as described in FIG. 1A).

In an embodiment, the trim retainer 200 further comprises an engagement mechanism 212 disposed on the retention member 204 and adapted to engage the portion of the seat frame 108 in a retention space 216. In an embodiment, the engagement mechanism 212 can have an elongated shape such as a protrusion or hook designed to interlock with the seat frame 108. In an embodiment, the engagement mechanism 212 can include various forms of mechanical fasteners, such as hooks, snaps, clips, or other interlocking features, which facilitate a secure and reliable attachment of the retention member 204 to the seat frame 108. In an embodiment, the engagement mechanism 212 enables that the retention member 204 remains firmly anchored to the seat frame 108, even under dynamic conditions such as the vehicle movement or user interactions with the seat assembly 104. In an embodiment, the seat frame 108 may include another hook portion that is adapted to engage with the engagement mechanism 212. In such an embodiment, the hook portion may complement the shape of the engagement mechanism 212 to form a locking mechanism. Moreover, the retention member 204 facilitates the transfer of the plurality of forces between the seat frame 108 and the trim retainer 200 to minimize stress on the various seat components. In an embodiment, the U-shaped design of the retention member 204 facilitates an efficient force distribution. The downward-facing portion of the U-shape is optimally positioned to receive and disperse the plurality of forces exerted on the seat assembly 104, thus enhancing durability and resistance to deformation of the seat assembly 104.

In an embodiment, the retention space 216 is adapted to provide an anchor point for the retention member 204. In such an embodiment, the retention member 204 is adapted to facilitate a transfer of a plurality of forces to the seat frame 108. Said transfer of the plurality of forces includes both static and dynamic loads that the seat assembly 104 may encounter during use. It will be appreciated that the retention space 216 prevents undue stress or deformation of the trim cover 112 and other components by effectively distributing the plurality of forces to the seat frame 108. The plurality of force distribution enables the trim cover 112 to remain securely attached and that the overall seat assembly 104 performs reliably over time.

There is also shown, the support member 208 that is adapted to guide the trim cover 112 such that the seat cushion 110 is fixed between the seat frame 108 and the trim cover 112. In an embodiment, the support member 208 can be adapted to counteract upward or lateral movements of the seat cushion 110. Said configuration enables that the seat cushion 110 is held firmly in place, preventing any upward or lateral movements that could affect the comfort and stability of the seat assembly 104. In an embodiment, the support member 208 is designed to provide continuous support to the trim cover 112. In an embodiment, the support member 208 extends from the retention member 204 at a predetermined angle within a range from about 10 degrees to about 120 degrees. In an embodiment, said angular range allows for flexibility in the design and positioning of the support member 208. In an embodiment, the predetermined angle can be selected based on factors such as the specific design of the seat frame 108, the desired tension in the trim cover 112, and the need to counteract specific movements of the seat cushion 110.

Referring to FIG. 2B illustrated is a schematic illustration of the trim retainer 200 creating tension in the trim cover 112, in accordance with another exemplary embodiment of the present disclosure. As shown, the trim retainer 200 comprises the retention space 216 adapted for providing an anchor point for the retention member 204. Herein, the anchor point is adapted to provide a point of contact for the engagement of the retention member 204 with the portion of the seat frame 108. As shown, the retention space 216 is a cavity or a designated area where the retention member 204 can securely engage with the seat frame 108, thereby acting as the anchor point. It will be appreciated that the design of the retention space 216 enables that the retention member 204 snugly fits around the seat frame 108. Thus, providing a stable and reliable connection that resists disengagement during dynamic conditions such as the vehicle movement.

In an embodiment, the retention member 204 is adapted for facilitating the transfer of the plurality of forces to the seat frame 108. Herein, the plurality of forces refers to the various types of forces acting on the seat assembly 104. In an example, the plurality of forces can be static forces or dynamic forces. In another example, the static forces may include constant forces that act on the seat assembly 104 when the seat assembly 104 is at rest. Examples may include a weight of the occupant, a weight of the seat assembly 104 itself, and any external forces acting on the seat assembly, such as those from cargo or other objects placed on the seat cushion 110. In another example, the dynamic forces may include forces that change over time. For example, the dynamic forces may include acceleration forces that can be experienced during vehicle acceleration, deceleration, and cornering. In another example, the dynamic forces may include vibration forces that can be caused by road irregularities and engine vibrations. In another example, the dynamic forces may include impact forces that are generated during collisions or sudden impacts.

In an embodiment, the retention member 204 distributes the impact over a larger area of the seat frame 108 rather than concentrating the impact at a single point 222 by decentralizing the forces such as 220. The retention member 204 reduces the stress concentration and minimizes the risk of failure at any specific spot of the seat cushion 110. As shown, the configuration of the retention member 204 is such that the retention member 204 directs more force such as 222 towards the bottom of the seat frame 108. The bottom-oriented force 222 channeling may allow better distribution of the stress across the seat frame 108, thereby enhancing the overall durability and structural integrity of the seat assembly 104. In an exemplary embodiment, there is shown the retention member 204 adapted to apply one or more forces 226 at a point such that the trim cover 112 is being pulled across the support member 208.

As shown, the trim retainer 200 is designed to pull the trim cover 112 tightly over the seat frame 108, thus creating higher tension in the trim cover 112. The tensioned state of the trim cover 112 leads to a firmer seat surface, which helps in maintaining the shape of the seat cushion 110 and providing better support to the occupant. Additionally, the higher tension also helps in reducing slack or looseness in the trim cover 112.

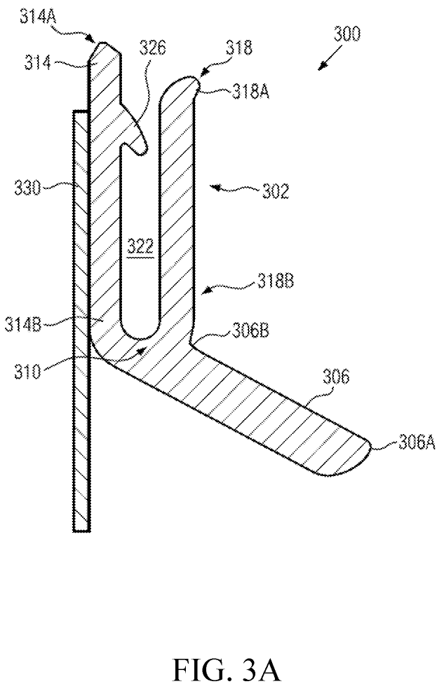

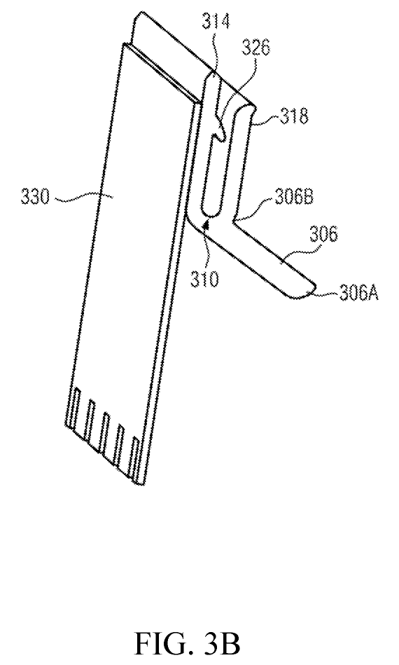

Referring to FIG. 3A, illustrated is a schematic illustration of a trim retainer 300, in accordance with yet another exemplary embodiment of the present disclosure. As shown, the trim retainer 300 for a seat assembly comprises a retention member 302 and a support member 306 that extends away from the retention member 302. In an embodiment, the retention member 302 forms a base structure of the trim retainer 300. The retention member 302 comprises a base portion 310 and two elongated members such as the first elongated member 314 and the second elongated member 318. The first elongated member 314 and the second elongated member 318 are positioned parallel to each other, thus creating a U-shaped configuration. In an embodiment, the U-shaped configuration of the retention member 302 facilitates effective force distribution, spreading the load across a wider area and reducing stress concentration. The first elongated member 314 comprises a first free end 314A and a first fixed end 314B. In an embodiment, the first elongated member 314 is adapted to at least partially engage with one end of the trim cover 112 of the seat assembly. Moreover, the first elongated member 314 is adapted to engage and pull the trim cover 112 (as depicted in FIG. 1A) in order to create tension in the trim cover 112. It will be appreciated that the tension enhances the fit of the trim cover 112 and prevents sagging of the trim cover 112.

Additionally, the retention member 302 comprises the second elongated member 318 that comprises a second free end 318A and a second fixed end 318B. The second fixed end 318B is connected to the first fixed end 314B such that the first elongated member 314 is positioned parallel to the second elongated member 318. Said parallel arrangement facilitates the creation of a secure and stable engagement with the seat frame 108 (as depicted in FIG. 1A). In an embodiment, each of the first elongated member 314 and the second elongated member 318 comprises a pre-determined height such that the pre-determined height of the first elongated member 314 is greater than the pre-determined height of the second elongated member 318. The term "pre-determined height"refers to a measured vertical length of each elongated member as designed and manufactured. In an embodiment, the pre-determined height is calculated based on the design requirements of the seat assembly. It will be appreciated that the first elongated member 314 being taller than second elongated member 318 in order to allow efficient receiving of the seat frame between the first elongated member 314 and the second elongated member 318. The height differential creates a smooth passageway, facilitating easier insertion and secure positioning of the seat frame within the retention space 322. In other words, said configuration forms an inclined pathway that guides the seat frame into the retention space 322. For instance, when the seat frame is inserted, the longer first elongated member 314 helps to align and position the seat frame, while the shorter second elongated member 318 provides a lower boundary that secures the seat frame in place. Said smooth insertion reduces the likelihood of misalignment or improper engagement, which can compromise the stability of the trim cover and the seat assembly. In an embodiment, the pre-determined height configuration helps distribute forces evenly along the seat frame. The even distribution reduces stress concentrations that could lead to material fatigue or failure, thereby enhancing the durability and reliability of the seat assembly.

In an embodiment, the first elongated member 314 and the second elongated member 318 are designed to conform to a contour of the seat frame 108. In such an embodiment, the shapes and curves of the first elongated member 314 and the second elongated member 318 are specifically tailored to fit the unique geometry and profile of the seat frame. It will be appreciated that the first elongated member 314 and the second elongated member 318 are manufactured with curves and bends that mirror the contour of the seat frame 108. In an embodiment, the contouring can be achieved through precision molding or machining processes, enabling that every point of contact between the elongated members and the seat frame fits snugly when the seat frame is inserted into the retention space 322. In an embodiment, the conforming shapes of the first elongated member 314 and the second elongated member 318 allow for a tight and secure engagement, holding the seat frame in place without gaps or loose areas. In another embodiment, when the first elongated member 314 and the second elongated member 318 match the contour of the seat frame, forces applied during use or impact are distributed more evenly along the seat frame. The even distribution helps in minimizing stress concentrations, which can prevent material fatigue and potential failure. Additionally, the snug fit reduces vibrations and noise, contributing to a more comfortable and quieter ride for the occupants. In an embodiment, the ability to customize the first elongated member 314 and the second elongated member 318 for different seat frame designs further expands the applicability and versatility of the trim retainer 300 in various vehicles.

In an embodiment, the first elongated member 314 is fabricated using a polymer material. In an embodiment, the first elongated member 314 is fabricated using a plastic material. In an embodiment, the first elongated member 314 is fabricated using a metal. In an embodiment, the first elongated member 314 is fabricated using a non-metal. In an embodiment, the first elongated member 314 is fabricated using a combination material. In an embodiment, each material can be chosen to optimize the performance and functionality of the trim retainer 300. For instance, when using the polymer material, the first elongated member 314 benefits from being lightweight and corrosion-resistant, making the trim retainer 300 suitable for reducing the weight of the seat assembly and improving fuel efficiency. An example of the polymer may include, but is not limited to a polyethylene, which provides excellent flexibility and impact resistance. Alternatively, fabricating the first elongated member 314 from the plastic material, such as polypropylene, offers cost-effectiveness and ease of molding, allowing for intricate designs that enhance the component's fit and function. In an embodiment, the plastics also provide thermal and electrical insulation, which is beneficial in preventing heat transfer and electrical conductivity within the seat assembly.

In an embodiment, the first elongated member 314 is made from the metal, such as aluminum or steel, in order to gain high strength and durability that is essential for maintaining the structural integrity of the seat assembly under high loads and stresses. In an embodiment, using the non-metal material, such as a ceramic or a composite, can offer advantages such as superior corrosion resistance, lightweight properties, and thermal insulation. Furthermore, in another embodiment, the first elongated member 314 is fabricated using a combination material, which could include composites such as fiberglass or carbon fiber. In an embodiment, the combination materials offer an optimized strength-to-weight ratio, enhanced flexibility and rigidity. In an embodiment, the material flexibility allows for customization to meet specific vehicle model requirements and design specifications, ensuring that the trim retainer 300 performs effectively in various applications while enhancing user comfort, safety, and sustainability.

As shown, the trim retainer 300 further comprises the retention space 322 that is formed by the gap between the first elongated member 314 and the second elongated members 318. The retention space 322 accommodates a portion of the seat frame, thereby providing a secure anchor point for the trim retainer 300. There is also shown a support member 306 that extends away from the base portion 310. The support member 306 counteracts upward and lateral forces on the seat cushion, thus maintaining its position and preventing discomfort. In an embodiment, the support member 306 extends away from the base portion 310 at the predetermined angle within a range from about 10 degrees to about 120 degrees. For instance, at the lower end of the range, the predetermined angle between about 10 degrees to about 30 degrees might be used in seat assemblies where minimal movement restriction of the seat cushion is required, while still providing adequate support. In an embodiment, at medium angles, ranging from about 30 degrees to about 60 degrees, the support member 306 is adapted to provide both flexibility and substantial support. Said range might be particularly useful in standard automotive seats where there is a need to counteract moderate movements of the seat cushion without overly restricting comfort. Said angles ensure that the trim cover remains taut and the seat cushion stable. Furthermore, the flexibility in angle can allow easy modifications in the seat design to meet different regulatory and ergonomic standards without requiring significant changes to the overall seat assembly structure.

As shown, the support member 306 comprises a third free end 306A and a third fixed end 306B. In an embodiment, the third fixed end is fixed to the base portion 310 of the retention member 302. In an embodiment, the support member 306 is adapted to guide the trim cover such that a movement of the seat cushion is restricted with respect to the seat frame. Said guidance enables that the seat cushion remains securely positioned, preventing the seat cushion from shifting or becoming dislodged, which can enhance passenger comfort and maintain the aesthetic of the seat assembly.

Additional embodiments may include variations in the angle and design of the support member 306 to suit different applications and vehicle types. Furthermore, alternative embodiments could involve different shapes or cross-sectional profiles of the support member 306. For instance, the support member 306 could be designed with a wider base or additional reinforcement features to enhance its load-bearing capacity and stability. Said design modifications would ensure that the support member 306 can handle varying stress levels and maintain its effectiveness across different use cases.

In an embodiment, each of the first elongated member 314, the second elongated member 318, and the support member 306 are adapted to apply a plurality of forces in response to impacts on the seat cushion. In an embodiment, the plurality of forces can be directed in a manner opposite to the direction of the impact. Said design strategy enables that, during scenarios such as collisions or abrupt vehicle maneuvers, each of the first elongated member 314, the second elongated member 318, and the support member 306 exert a counteracting force that effectively creates tension in the trim cover. The technical effect of this configuration is that it enables that the trim cover is tightly secured over the seat cushion, preventing any displacement or loosening that could occur under high-stress conditions. The counteracting forces help absorb and distribute the impact energy, mitigating potential damage to the seat cushion and the trim cover.

In an embodiment, the trim retainer 300 further comprises an engagement mechanism 326 disposed on the first elongated member 314 and adapted to engage the seat frame in the retention space 322. In an embodiment, the engagement mechanism 326, located on the first elongated member 314 further enhances the connection between the trim retainer 300 and the seat frame. As shown, the engagement mechanism 326 is adapted to be disposed at an upper portion of the first elongated member 314 that is proximal to the first free end 314A. In another embodiment, the engagement mechanism 326 can be disposed on the second elongated member 314 to enhance the connection between the trim retainer 300 and the seat frame. In an embodiment, the retention space 322, in conjunction with the engagement mechanism 326, secures the trim retainer 300 to the seat frame, providing stability and preventing movement of the seat cushion.

In an embodiment, the trim retainer 300 further comprises a first layer 330. In an embodiment, the first layer 330 is adapted to be at least partially attached to the retention member 302. In an embodiment, the first layer 330 is adapted to facilitate an attachment of the trim cover 112 with the retention member 302. Herein, the first layer 330 is an additional layer adapted to be attached to the trim retainer 300 that provides an interface between the trim cover 112 and the retention member 302. In an embodiment, the first layer 330 is adapted to facilitate an attachment of the trim cover 112 with the retention member 302. In an embodiment, the first layer 330 can be designed as an intermediary layer that enhances the connection between the trim cover 112 and the retention member 302. In an embodiment, the first layer 330 can be made from various materials that offer properties such as adhesion, friction, or flexibility, which aid in securing the trim cover 112 to the retention member 302. In one embodiment, the first layer 330 can have an adhesive surface that bonds directly to the trim cover 112, enabling a firm attachment that prevents slippage. Alternatively, the first layer 330 could be made from a high-friction material, providing a gripping surface that holds the trim cover 112 in place through mechanical friction. In an embodiment, the first layer 330 may also have a textured or contoured surface designed to interlock with corresponding features on the trim cover 112, thus securing the first layer 330 through physical engagement. Furthermore, in some embodiments, the first layer 330 might be elastic or flexible, allowing the first layer 330 to conform to the shape of the trim cover 112 and retention member, thereby accommodating variations in shape and ensuring a snug fit. In an embodiment, the first layer 330 is adapted to be fabricated using a nonwoven material. In an embodiment, the first layer 330 is adapted to be fabricated using a spacer fabric. In an embodiment, the first layer 330 is adapted to be fabricated using a fleece. In an embodiment, the first layer 330 is adapted to be fabricated using an elastic material. In an embodiment, the first layer 330 is adapted to be fabricated using a textile. In an embodiment, the first layer 330 is adapted to be fabricated using a combination of the aforementioned materials. It will be appreciated that the aforementioned materials are adapted to provide flexibility while securing the trim cover 112 to the first elongated member 314.

Referring to FIG. 3B, illustrated is a schematic illustration of a perspective view of the trim retainer 300, in accordance with yet another exemplary embodiment of the present disclosure. As shown, the first elongated member 314 and the second elongated member 318 can be designed as two parallel plates adapted to be arranged parallel and opposite to each other. In an embodiment, the first elongated member 314 comprises a first outer wall and a first inner wall such that the first outer wall is adapted to be attached to the first layer 330 and the first inner layer is adapted to face a second inner layer of the second elongated member 318. In such an embodiment, a second outer layer of the second elongated member 318 is adapted to be attached to the seat cushion 110 (as depicted in FIG. 1A and 2B). In an embodiment, the support member 306 can be designed as a plate that compliments the shape and design of the second elongated member 318. Said design enables that the support member 306 provides consistent and reliable support to the trim cover, aligning with the contours of the second elongated member 318. The support member 306 is adapted to be removably attached to the base portion 310 of the trim retainer 300. Said removable attachment feature allows for easy maintenance and replacement of the support member 306 when needed. Thus, enhancing the versatility and adaptability of the trim retainer 300. In an embodiment, the trim retainer 300 not only secures the trim cover effectively but also provides a flexible solution that can accommodate various seat frame configurations and design requirements by incorporating said design elements.

In a first aspect, the present disclosure provides a trim retainer for a seat assembly. The trim retainer comprises a retention member and a support member extending from the retention member. The retention member is adapted to be disposed at a portion of a seat frame and adapted to engage with the portion of the seat frame. The retention member is adapted to at least partially engage with a trim cover and pull the trim cover towards the portion of the seat frame of the seat assembly. The support member is adapted to guide the trim cover such that a movement of a seat cushion is restricted with respect to the seat frame.

In an embodiment, the trim retainer further comprises an engagement mechanism disposed on the retention member. In an embodiment, the engagement mechanism is adapted to engage the portion of the seat frame in a retention space.

In an embodiment, the retention space is adapted to provide an anchor point for the retention member. In an embodiment, the retention space is adapted to facilitate a transfer of a plurality of forces to the seat frame.

In an embodiment, the support member is adapted to guide the trim cover such that the seat cushion is fixed between the seat frame and the trim cover. In an embodiment, the support member is adapted to counteract displacement such as upward or lateral movements of the seat cushion relative to the seat frame.

In an embodiment, the support member extends from the retention member at a predetermined angle within a range from about 10 degrees to about 120 degrees.

In an embodiment, the trim retainer further comprises a first layer adapted to be at least partially attached to the retention member. In an embodiment, the first layer is adapted to attach the trim cover with the retention member.

In an embodiment, the first layer is adapted to be fabricated using at least one of: a nonwoven material, a spacer fabric, a fleece, an elastic material, a textile, or a combination thereof.

In a second aspect, the present disclosure provides a trim retainer for a seat assembly. The trim retainer comprises a retention member and a support member. The retention member comprises a base portion, a first elongated member extending from the base portion, a second elongated member extending from the base portion, a retention space between the first elongated member and the second elongated member and a support member. The first elongated member comprises a first free end and a first fixed end. The first elongated member is adapted to at least partially engage with a trim cover of the seat assembly. The second elongated member comprises a second free end and a second fixed end. The second fixed end is connected to the first fixed end such that the first elongated member is positioned parallel to the second elongated member. The retention space is adapted to engage with a portion of a seat frame of the seat assembly. The support member comprises a third free end and a third fixed end, wherein the third fixed end is fixed to the base portion of the retention member such that the support member extends away from the base at a predetermined angle. The support member is adapted to guide the trim cover such that a movement of a seat cushion is restricted with respect to the seat frame.

In an embodiment, the support member extends away from the base at the predetermined angle within a range from about 10 degrees to about 120 degrees.

In an embodiment, each of the first elongated member and the second elongated member comprises a pre-determined height such that the pre-determined height of the first elongated member is greater than the pre-determined height of the second elongated member.

In an embodiment, the trim retainer further comprises an engagement mechanism disposed on the first elongated member and adapted to engage the seat frame in the retention space.

In an embodiment, the first elongated member and the second elongated member are adapted to conform to a contour of the seat frame.

In an embodiment, each of the first elongated member, the second elongated member, and the support member is adapted to apply a plurality of forces during an impact on the seat cushion such that the plurality of forces is adapted to create tension in the trim cover. In an embodiment, the plurality of forces is applied in a direction opposite to the impact.

In an embodiment, the first elongated member is fabricated using at least one of: a polymer material, a plastic material, a metal, a non-metal, or a combination material.

In a third aspect, the present disclosure provides a seat assembly. The seat assembly comprises a seat frame, a seat cushion adapted to be attached to the seat frame, a trim cover adapted to cover the seat cushion, and a trim retainer adapted to be engaged with the seat frame and the trim cover. The trim retainer comprises a retention member adapted to be disposed at a portion of the seat frame and adapted to engage with the portion of the seat frame. The retention member is adapted to at least partially engage with the trim cover. The support member is adapted to guide the trim cover such that a movement of the seat cushion is restricted with respect to the seat frame.

In an embodiment, the seat assembly further comprises an engagement mechanism disposed on the retention member and adapted to engage the portion of the seat frame in a retention space.

In an embodiment, the retention space is adapted to provide an anchor point for the retention member and adapted to facilitate a transfer of a plurality of forces to the seat frame.

In an embodiment, the support member is adapted to guide the trim cover such that the seat cushion is fixed between the seat frame and the trim cover and adapted to counteract displacement of the seat cushion relative to the seat frame.

In an embodiment, the support member extends from the retention member at a predetermined angle within a range from about 10 degrees to about 120 degrees.

In an embodiment, the seat assembly further comprises a first layer adapted to be at least partially attached to the retention member, wherein the first layer is adapted to attach the trim cover with the retention member.

FIGS. 1A-B, 2A-B, and 3A-B are merely examples, which should not unduly limit the scope of the claims herein. A person skilled in the art will recognize many variations, alternatives, and modifications of embodiments of the present disclosure.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A trim retainer for a seat assembly, comprising:
a retention member adapted to be disposed at a portion of a seat frame and adapted to engage with the portion of the seat frame, wherein the retention member is adapted to at least partially engage with a trim cover and pull the trim cover towards the portion of the seat frame of the seat assembly; and
a support member extending from the retention member, wherein the support member is adapted to guide the trim cover such that a movement of a seat cushion is restricted with respect to the seat frame.

2. The trim retainer of claim 1, further comprising an engagement mechanism disposed on the retention member and adapted to engage the portion of the seat frame in a retention space.

3. The trim retainer of claim 2, wherein the retention space is adapted to provide an anchor point for the retention member and adapted to facilitate a transfer of a plurality of forces to the seat frame.

4. The trim retainer of claim 1, wherein the support member is adapted to guide the trim cover such that the seat cushion is fixed between the seat frame and the trim cover and adapted to counteract displacement of the seat cushion relative to the seat frame.

5. The trim retainer of claim 1, wherein the support member extends from the retention member at a predetermined angle within a range from about 10 degrees to about 120 degrees.

6. The trim retainer of claim 1, further comprising a first layer adapted to be at least partially attached to the retention member, wherein the first layer is adapted to attach the trim cover with the retention member.

7. The trim retainer of claim 1, wherein the first layer is adapted to be fabricated using at least one of: a nonwoven material, a spacer fabric, a fleece, an elastic material, a textile, or a combination thereof.

8. A trim retainer for a seat assembly comprising:
a retention member, wherein the retention member comprises:
a base portion,
a first elongated member extending from the base portion, the first elongated member comprises a first free end and a first fixed end, and wherein the first elongated member is adapted to at least partially engage with a trim cover of the seat assembly,
a second elongated member extending from the base portion, the second elongated member comprises a second free end and a second fixed end, wherein the second fixed end is connected to the first fixed end such that the first elongated member is positioned parallel to the second elongated member, and
a retention space between the first elongated member and the second elongated member and adapted to engage with a portion of a seat frame of the seat assembly; and
a support member comprising a third free end and a third fixed end, wherein the third fixed end is fixed to the base portion of the retention member such that the support member extends away from the base at a predetermined angle, and wherein the support member is adapted to guide the trim cover such that a movement of a seat cushion is restricted with respect to the seat frame.

9. The trim retainer of claim 8, wherein the support member extends away from the base at the predetermined angle within a range from about 10 degrees to about 120 degrees.

10. The trim retainer of claim 8, wherein each of the first elongated member and the second elongated member comprises a pre-determined height such that the pre-determined height of the first elongated member is greater than the pre-determined height of the second elongated member.

11. The trim retainer of claim 8, further comprising an engagement mechanism disposed on the first elongated member and adapted to engage the seat frame in the retention space.

12. The trim retainer of claim 8, wherein the first elongated member and the second elongated member are adapted to conform to a contour of the seat frame.

13. The trim retainer of claim 8, wherein each of the first elongated member, the second elongated member, and the support member is adapted to apply a plurality of forces during an impact on the seat cushion such that the plurality of forces is adapted to create tension in the trim cover, and wherein the plurality of forces is applied in a direction opposite to the impact.

14. The trim retainer of claim 8, wherein the first elongated member is fabricated using at least one of: a polymer material, a plastic material, a metal, a non-metal, or a combination material.

15. A seat assembly, comprising:
a seat frame;
a seat cushion adapted to be attached to the seat frame; a trim cover adapted to cover the seat cushion; and
a trim retainer adapted to be engaged with the seat frame and the trim cover, wherein the trim retainer comprises:
a retention member adapted to be disposed at a portion of the seat frame and adapted to engage with the portion of the seat frame, wherein the retention member is adapted to at least partially engage with the trim cover; and
a support member extending from the retention member, wherein the support member is adapted to guide the trim cover such that a movement of the seat cushion is restricted with respect to the seat frame.

16. The seat assembly of claim 15, further comprising an engagement mechanism disposed on the retention member and adapted to engage the portion of the seat frame in a retention space.

17. The seat assembly of claim 16, wherein the retention space is adapted to provide an anchor point for the retention member and adapted to facilitate a transfer of a plurality of forces to the seat frame.

18. The seat assembly of claim 15, wherein the support member is adapted to guide the trim cover such that the seat cushion is fixed between the seat frame and the trim cover and adapted to counteract displacement of the seat cushion relative to the seat frame.

19. The seat assembly of claim 15, wherein the support member extends from the retention member at a predetermined angle within a range from about 10 degrees to about 120 degrees.

20. The seat assembly of claim 15, further comprising a first layer adapted to be at least partially attached to the retention member, wherein the first layer is adapted to attach the trim cover with the retention member.
